(19) United States
(12) Patent Application Publication
(10) Pub. No.: US 2025/0237825 A1
(43) Pub. Date: Jul. 24, 2025

(54) OPTICAL MODULE AND COMMUNICATION APPARATUS

(71) Applicant: NEC Corporation, Tokyo (JP)

(72) Inventor: Yuuji MINOTA, Tokyo (JP)

(73) Assignee: NEC Corporation, Tokyo (JP)

(21) Appl. No.: 18/973,548

(22) Filed: Dec. 9, 2024

(30) Foreign Application Priority Data
Jan. 23, 2024 (JP) 2024-007744

(51) Int. Cl. G02B 6/42; H04B 10/25

(52) U.S. Cl. CPC G02B 6/4269; G02B 6/4246; H04B 10/25

(57) ABSTRACT

To provide an optical module and a communication apparatus that can be mounted at high density, an optical module according to the present disclosure includes: a substrate; an integrated circuit having a first surface and a second surface opposite to the first surface, and being attached to the substrate in such a way that the first surface faces the substrate; an optical component being attached to the substrate; an optical fiber being connected to the optical component; and a base material portion being attached to the integrated circuit and holding at least a part of the optical fiber, and the optical fiber includes a first portion and a second portion passing through the second surface.

### INCORPORATION BY REFERENCE

This application is based upon and claims the benefit of priority from Japanese patent application No. 2024-007744, filed on Jan. 23, 2024, the disclosure of which is incorporated herein in its entirety by reference.

### TECHNICAL FIELD

The present disclosure relates to an optical module and a communication apparatus.

### BACKGROUND ART

Patent Literature 1 discloses an optical module used for optical communication. For example, it is required that an optical transceiver used for optical communication is equipped with various components such as an integrated circuit such as a field programmable gate array (FPGA), an optical transmitter, and an optical receiver. In such an optical transceiver, these components are mounted at high density in order to achieve miniaturization while increasing the number of components to be mounted.

[Patent Literature 1] Japanese Unexamined Patent Application Publication No.2000-196112

[Patent Literature 2] Japanese Unexamined Patent Application Publication No.2011-059360

[Patent Literature 3] International Patent Publication No. WO2019/181762

### SUMMARY

In such an optical transceiver, an optical fiber that connects between optical components is equipped on a substrate, in addition to an electronic device or an optical component. However, when the optical fiber is equipped in the optical transceiver, it is necessary to provide the optical fiber with other components in such a way as not to interfere with each other. However, in such a case, an area where an optical fiber is attached is required in addition to an area where each component is attached, and thus, the optical fiber hinders high-density mounting of other components.

An example object of the present disclosure is made in order to solve the above-described problem, and is to provide an optical module that can be mounted at high density.

In a first example aspect, an optical module according to the present disclosure includes: a substrate; an integrated circuit configured to have a first surface and a second surface in an opposite side to the first surface, and be attached to the substrate in such a way that the first surface faces the substrate; an optical component configured to be attached to the substrate; an optical fiber configured to be connected to the optical component; and a base material portion configured to be attached to the integrated circuit, and hold at least a part of the optical fiber. The optical fiber includes a first portion configured to pass through the second surface, and a second portion configured to pass through the second surface.

In a second example aspect, a communication apparatus according to the present disclosure includes the optical module.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a perspective view illustrating an optical module according to the present disclosure;

FIG. 2 is a perspective view illustrating the optical module according to the present disclosure, and is an enlarged view of an II area in FIG. 1; and

FIG. 3 is a perspective view illustrating a housing in the optical module according to the present disclosure.

### EXAMPLE EMBODIMENT

Hereinafter, an example embodiment of the present disclosure will be described with reference to the drawings. Note that, the following description and drawings are omitted and simplified as appropriate for clarity of description. Further, in each following drawing, the same elements are denoted by the same reference signs, and redundant descriptions are omitted as necessary.

### First Example Embodiment

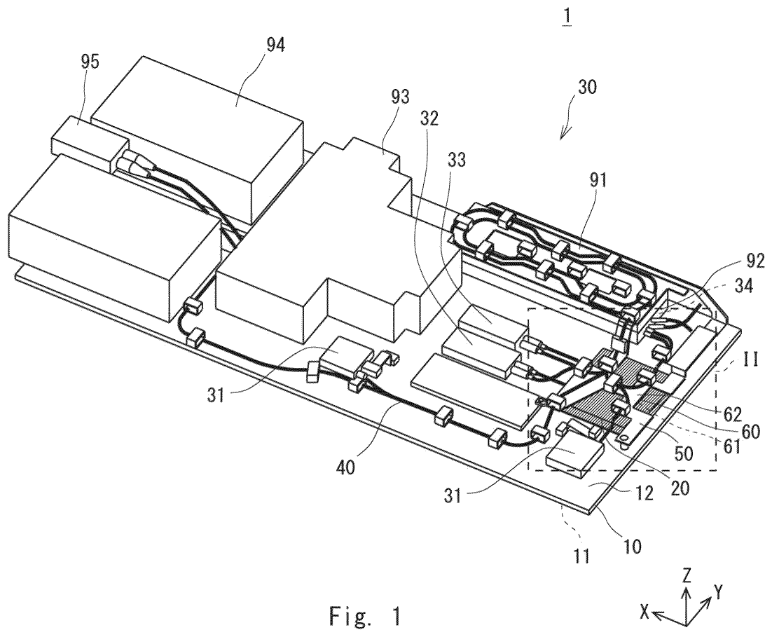

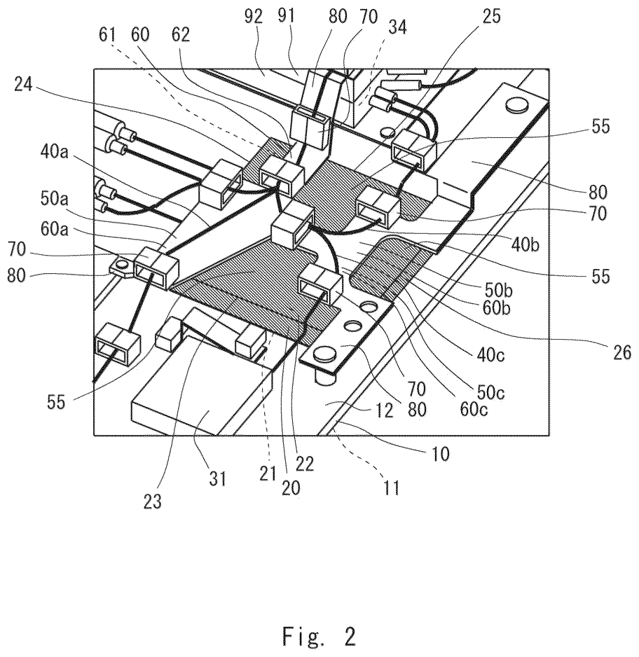

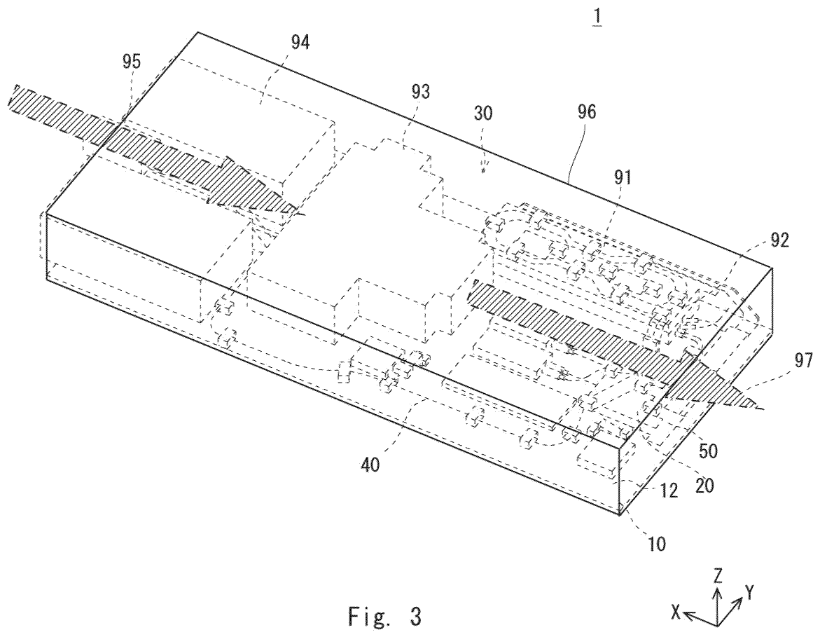

An optical module according to a first example embodiment will be described. FIG. 1 is a perspective view illustrating an optical module according to the present disclosure. FIG. 2 is a perspective view illustrating the optical module according to the present disclosure, and is an enlarged view of an II area in FIG. 1. FIG. 3 is a perspective view illustrating a housing in the optical module according to the present disclosure. In FIGS. 1 to 3, some reference signs are omitted in such a way as not to complicate the drawings.

As illustrated in FIGS. 1 to 3, an optical module 1 includes a substrate 10, an integrated circuit 20, an optical component 30, an optical fiber 40, and a base material portion 50. In addition, the optical module 1 may further include a first optical fiber accommodating portion 91, a second optical fiber accommodating portion 92, a heat sink 93, a connector 94, an adapter 95, and a housing 96. Note that, another member may be added to the optical module 1, or some of these members may be omitted. The optical module 1 has a function as an optical transceiver, and is used for a communication apparatus.

The substrate 10 has, for example, a rectangular plate shape, and has two surfaces opposite to each other. Each of the two surfaces is referred to as a first surface 11 and a second surface 12. Therefore, the substrate 10 has the first surface 11 and the second surface 12. The second surface 12 is a surface in an opposite side to the first surface 11.

Herein, for convenience of description of the optical module 1, an XYZ orthogonal coordinate system is introduced. A direction orthogonal to the second surface 12 is defined as a Z-axis direction, and a plane parallel to the second surface 12 is defined as an XY plane. A direction in which the second surface 12 faces is defined as a +Z-axis direction, and an opposite direction thereof is defined as a −Z-axis direction. There is a case where the +Z-axis direction is referred to as upward, and the −Z-axis direction is referred to as downward. Note that, upward and downward are for convenience of description of the optical module 1, and do not indicate a direction in which the actual optical module 1 is arranged.

The integrated circuit 20 has, for example, a rectangular plate shape, and has two surfaces opposite to each other. Each of the two surfaces is referred to as a first surface 21 and a second surface 22. Therefore, the integrated circuit 20 has the first surface 21 and the second surface 22. The second surface 22 is a surface in an opposite side to the first surface 21. In FIGS. 1 and 2, the integrated circuit 20 is hatched. The integrated circuit 20 controls operation of each member in the optical module 1. The integrated circuit 20 includes, for example, an FPGA. Note that, the integrated circuit 20 is not limited to the FPGA as long as it controls the operation of each member in the optical module 1, and may include another circuit such as a CPU.

The integrated circuit 20 is attached to a second surface 12 side of the substrate 10. The integrated circuit 20 is attached to the substrate 10 in such a way that the first surface 21 faces the substrate 10. The integrated circuit 20 may be arranged on a −X-axis direction side in the second surface 12 of the substrate 10. The base material portion 50 is arranged on the second surface 22 of the integrated circuit 20. The integrated circuit 20 may be held on the substrate 10 by the base material portion 50.

The optical component 30 includes a light source 31, an optical transmitter 32, an optical receiver 33, and an optical fiber type amplifier 34. In addition, the optical component 30 may further include another member. The optical component 30 is attached to the substrate 10. For example, each of the optical components 30 is arranged on the second surface 12 of the substrate 10. Each of the optical components 30 is arranged, for example, on the −X-axis direction side relative to the heat sink 93 in the second surface 12 of the substrate 10. The heat sink 93 has a cooling function. The optical transmitter 32 and the optical receiver 33 are, for example, arranged side by side in a Y-axis direction in a central portion between the heat sink 93 and the integrated circuit 20. The light source 31 is arranged on a −Y-axis direction side in the second surface 12 of the substrate 10, and the optical fiber type amplifier 34 is arranged on a +Y-axis direction side in the second surface 12 of the substrate 10.

The integrated circuit 20, the optical transmitter 32 or the optical receiver 33, and the heat sink 93 are arranged in such a way as to align in a plane parallel to the second surface 12 of the substrate 10. With such an arrangement, a cooling effect of the integrated circuit 20, and the optical transmitter 32, the optical receiver 33, and the like in the optical component 30 can be improved.

The light source 31 generates light used for an optical signal. The light source 31 includes, for example, an integrable tunable laser assembly (hereinafter, referred to as an ITLA). Note that, the light source 31 is not limited to the ITLA as long as it generates light used for an optical signal. Although two light sources 31 are illustrated in the figure, only one of the light sources 31 may be used.

The optical transmitter 32 outputs an optical signal to which information is added. The optical transmitter 32 includes, for example, a code division multiplexing (hereinafter, referred to as a CDM). The optical transmitter 32 adds information by modulating light generated by the light source 31, and outputs an optical signal. The optical transmitter 32 is not limited to the CDM as long as it outputs an optical signal.

The optical receiver 33 receives an optical signal, and extracts information. The optical receiver 33 includes, for example, an intradyne coherent receiver (hereinafter, referred to as an ICR). The optical receiver 33 extracts information from an interference wave that causes input light and light generated by the light source 31 to interfere with each other. The optical receiver 33 is not limited to the ICR as long as it can receive an optical signal.

The optical fiber type amplifier 34 is accommodated inside the second optical fiber accommodating portion 92. The optical fiber type amplifier 34 amplifies an optical signal. For example, the optical fiber type amplifier 34 amplifies an optical signal being output from the optical transmitter 32. The optical fiber type amplifier 34 may include, for example, an erbium doped fiber amplifier (hereinafter, referred to as an EDFA). Note that, the optical fiber type amplifier 34 is not limited to the EDFA as long as it amplifies an optical signal.

The optical fiber 40 is connected to the optical component 30. For example, the optical fiber 40 connects predetermined members of the optical component 30 to each other. For example, the optical fiber 40 connects the light source 31 and the optical transmitter 32 to each other. Further, the optical fiber 40 connects the light source 31 and the optical receiver 33 to each other. Furthermore, the optical fiber 40 connects the optical transmitter 32 and the optical fiber type amplifier 34 to each other. When the light source 31 is connected to the optical transmitter 32 and the optical receiver 33, a coupler may be interposed between the light source 31, and the optical transmitter 32 and the optical receiver 33.

Further, the optical fiber 40 may connect the optical component 30 and the connector 94 to each other. For example, the optical fiber 40 connects the optical fiber type amplifier 34 and the connector 94 to each other. The optical fiber 40 connects the optical receiver 33 and the connector 94 to each other. An extra length portion of the optical fiber 40 may be accommodated in the first optical fiber accommodating portion 91.

The optical fiber 40 has a portion passing through the second surface 22 of the integrated circuit 20. For example, the optical fiber 40 includes a first portion 40a and a second portion 40b that pass through the second surface 22 of the integrated circuit 20. In this way, a plurality of portions of the optical fiber 40 pass through the second surface 22 of the integrated circuit 20, and thus, an area occupied by the optical fiber 40 on the second surface 12 of the substrate 10 can be reduced. Thus, each constituent member of the optical module 1 can be mounted at high density. Further, the plurality of portions of the optical fiber 40 passing through the second surface 22 of the integrated circuit 20 hold the integrated circuit 20 to the substrate 10 in a well-balanced manner. Thus, attachment, to the substrate 10, of the integrated circuit 20 being attached to the substrate 10 can be held.

The optical fiber 40 may further include a third portion 40c, in addition to the first portion 40a and the second portion 40b. Each of the first portion 40a, the second portion 40b, and the third portion 40c of the optical fiber 40 passes through the second surface 22 in such a way as to overcome the second surface 22 of the integrated circuit 20. The second surface 22 of the integrated circuit 20 has, for example, a rectangular shape, and has a first side 23, a second side 24, a third side 25, and a fourth side 26. The first side 23 and the third side 25 face each other, and the second side 24 and the fourth side 26 face each other.

The first portion 40a of the optical fiber 40 intersects, for example, the first side 23 and the third side 25. As described above, at least any of the first portion 40a and the second portion 40b of the optical fiber 40 intersects one side of the second surface 22 of the integrated circuit 20 and the other side opposite to the one side. One end of the first portion 40a is connected to the optical fiber 40 being connected to the light source 31. Specifically, an end portion of the first portion 40a on a side intersecting the first side 23 is connected to the optical fiber 40 being connected to the light source 31. Another end of the first portion 40a, that is, the end portion of the first portion 40a on a side intersecting the third side 25, for example, is connected to the optical fiber 40 being accommodated in the first optical fiber accommodating portion 91. Note that, a connection destination of the end portion of the first portion 40a is merely an example, and may be connected to the other optical component 30, the connector 94, or the like according to the specification and design of the optical module 1. The connection destinations of the second portion 40b and the third portion 40c are also similar.

The second portion 40b of the optical fiber 40 intersects, for example, the second side 24 and the third side 25. One end of the second portion 40b, for example, an end portion of the second portion 40b on a side intersecting the second side 24, may be connected to the optical fiber 40 being connected to the optical transmitter 32, or may be connected to the optical fiber 40 being connected to the optical receiver 33. Another end of the second portion 40b, that is, the end portion of the second portion 40b on a side intersecting the third side 25, may be connected to the optical fiber 40 being connected to the optical fiber type amplifier 34, or may be connected to the optical fiber 40 being accommodated in the first optical fiber accommodating portion 91.

The third portion 40c of the optical fiber 40 intersects, for example, the first side 23 and the third side 25. One end of the third portion 40c, for example, an end portion of the third portion 40c on a side intersecting the first side 23, is connected to the optical fiber 40 being connected to the light source 31. Another end of the third portion 40c, that is, the end portion of the third portion 40c on a side intersecting the third side 25, for example, is connected to the optical fiber 40 being accommodated in the first optical fiber accommodating portion 91.

The base material portion 50 is attached to the integrated circuit 20. For example, the base material portion 50 is attached in such a way as to straddle the second surface 22 of the integrated circuit 20. The base material portion 50 holds at least a part of the optical fiber 40. The base material portion 50 includes a holding portion 60, a plurality of guides 70, and a plurality of support portions 80 when classified by a type of members constituting the base material portion 50. The base material portion 50 includes a first base material portion 50a, a second base material portion 50b, and a third base material portion 50c when classified by a portion being attached to the integrated circuit 20.

The holding portion 60 is a portion arranged on the second surface 22 of the integrated circuit 20. The holding portion 60 may have a first surface 61, and a second surface 62 in an opposite side to the first surface 61. The holding portion 60 may have a plate shape, but is not limited thereto. The first surface 61 of the holding portion 60 faces the second surface 22 of the integrated circuit 20. The first surface 61 of the holding portion 60 holds the integrated circuit 20. The plurality of guides 70 are provided on the second surface 62 of the holding portion 60.

The guide 70 holds the optical fiber 40. The guide 70 is, for example, annular, and holds the optical fiber 40 therein. Note that, the guide 70 may have a shape other than an annular shape as long as it can hold the optical fiber 40. The optical fiber 40 passes through the second surface 22 of the integrated circuit 20 by passing through the guide 70.

The support portion 80 is a portion supporting the holding portion 60. The support portion 80 directly or indirectly fixes the holding portion 60 to the substrate 10. For example, one end of the support portion 80 is fixed to the substrate 10, and another end of the support portion 80 is connected to the holding portion 60.

The holding portion 60 includes a first holding portion 60a, a second holding portion 60b, and a third holding portion 60c. Each holding portion is arranged along the optical fiber 40 passing through the second surface 22 of the integrated circuit 20. One or a plurality of guides 70 are arranged on the second surface 62 of each holding portion. An end portion of each holding portion is connected to other holding portions, or is connected to the support portion 80. As a result, the support portion 80 supports each holding portion.

The first holding portion 60a has a portion arranged along the first portion 40a of the optical fiber 40. Specifically, the first holding portion 60a has a portion extending from the first side 23 to the third side 25 of the second surface 22 of the integrated circuit 20. Both ends of the first holding portion 60a are supported by the support portion 80. The first portion 40a of the optical fiber 40 passes through the second surface 22 of the integrated circuit 20 by being held by the first holding portion 60a. In this way, the first holding portion 60a holds the first portion 40a.

The second holding portion 60b has a portion arranged along the second portion 40b of the optical fiber 40. The second holding portion 60b overlaps with the first holding portion 60a at a portion intersecting the first holding portion 60a. In other words, the second holding portion 60b is connected to the first holding portion 60a at the portion intersecting the first holding portion 60a. An end portion of the second holding portion 60b on a side of the third side 25 is supported by the support portion 80. The second portion 40b of the optical fiber 40 passes through the second surface 22 of the integrated circuit 20 by being held by the second holding portion 60b. In this way, the second holding portion 60b holds the second portion 40b.

The third holding portion 60c has a portion arranged along the third portion 40c of the optical fiber 40. The third holding portion 60c overlaps with the first holding portion 60a and the second holding portion 60b at a portion intersecting the first holding portion 60a and the second holding portion 60b. In other words, the third holding portion 60c is connected to the first holding portion 60a and the second holding portion 60b at the portion intersecting the first holding portion 60a and the second holding portion 60b. An end portion of the third holding portion 60c on a side of the first side 23 is supported by the support portion 80. The third portion 40c of the optical fiber 40 passes through the second surface 22 of the integrated circuit 20 by being held by the third holding portion 60c. In this way, the third holding portion 60c holds the third portion 40c.

The first base material portion 50a includes the first holding portion 60a. Therefore, the first base material portion 50a holds the first portion 40a. The second base material portion 50b includes the second holding portion 60b. Therefore, the second base material portion 50b holds the second portion 40b. The third base material portion 50c includes the third holding portion 60c. Therefore, the third base material portion 50c holds the third portion 40c.

The base material portion 50 has a cutout portion 55 penetrating to the second surface 22 of the integrated circuit 20 in at least a part of a surface holding the first portion 40a, the second portion 40b, and the third portion 40c of the optical fiber 40 other than an area where a path of the optical fiber 40 is located. Specifically, the cutout portion 55 is formed between the first base material portion 50a and the second base material portion 50b. Therefore, the second surface 22 of the integrated circuit 20 is exposed between the first base material portion 50a and the second base material portion 50b. The cutout portion 55 is formed between the second base material portion 50b and the third base material portion 50c. Therefore, the second surface 22 of the integrated circuit 20 is exposed between the second base material portion 50b and the third base material portion 50c. The cutout portion 55 is formed between the third base material portion 50c and the first base material portion 50a. Therefore, the second surface 22 of the integrated circuit 20 is exposed between the third base material portion 50c and the first base material portion 50a.

As described above, the cutout portion 55 is provided in a portion of the base material portion 50 other than the area where the path of the optical fiber 40 is located, and thus, the integrated circuit 20 can be air-cooled.

The first optical fiber accommodating portion 91 accommodates a part of the optical fiber 40 not being held by the base material portion 50. In other words, the first optical fiber accommodating portion 91 accommodates an extra length portion of the optical fiber 40. The first optical fiber accommodating portion 91 is arranged on the +Z-axis direction side of the second optical fiber accommodating portion 92. In other words, the first optical fiber accommodating portion 91 is provided on the second optical fiber accommodating portion 92 in a laminated manner. The second optical fiber accommodating portion 92 accommodates the optical fiber type amplifier 34.

The heat sink 93, the connector 94, and the adapter 95 are also arranged on a side of the second surface 12 of the substrate 10. The connector 94 and the adapter 95 are arranged on a +X-axis direction side relative to the heat sink 93. The housing 96 accommodates the substrate 10, the integrated circuit 20, the optical component 30, the optical fiber 40, the base material portion 50, the first optical fiber accommodating portion 91, the second optical fiber accommodating portion 92, the heat sink 93, the connector 94, and the adapter 95. A thickness of the heat sink 93 from the second surface 12 of the substrate 10 is greater than the thickness of the integrated circuit 20 from the second surface 12 of the substrate 10. Thus, a space is formed on the second surface 22 side of the integrated circuit 20. As a result, cooled gas 97 from the heat sink 93 can cool the integrated circuit 20.

Next, an advantageous effect of the present example embodiment will be described. The optical module 1 of the present example embodiment includes the base material portion 50, and thereby the optical fiber 40 can be fixed on the integrated circuit 20. Thus, a part of an area on the substrate 10 used for fixing the optical fiber 40 is not required. As a result, the area used for fixing the optical fiber 40 can be reduced than in a case where the path of the optical fiber 40 is provided only on the substrate 10, and thus a mounting area of the members constituting the optical module 1 can be secured. With such a configuration, it is possible to mount at high density.

Further, the optical module 1 causes the first portion 40a and the second portion 40b of the optical fiber 40 to pass through the second surface 22 of the integrated circuit 20. As a result, holding force for fixing the integrated circuit 20 to the substrate 10 in a well-balanced manner can be improved. Further, the optical module 1 has the cutout portion 55 between the first base material portion 50a holding the first portion 40a and the second base material portion 50b holding the second portion 40b, and thus, an air cooling function of the integrated circuit 20 can be improved.

Moreover, in the optical module 1, by providing the first optical fiber accommodating portion 91 and the second optical fiber accommodating portion 92 in a laminated manner, it is possible to reduce the area used for fixing each optical fiber 40. Thus, a mounting area of the components constituting the optical module 1 can be secured.

Although the present disclosure has been described with reference to the example embodiment, the present disclosure is not limited to the above-described example embodiment. Various changes that can be understood by a person skilled in the art within the scope of the present disclosure can be made to the configuration and details of the present disclosure. Then, each configuration in the example embodiment can be combined as appropriate.

The drawings are merely illustrative of one or more example embodiments. Each drawing may be associated with one or more other example embodiments, rather than only one particular example embodiment. As those skilled in the art will appreciate, various features described with reference to any one of the figures may be combined with features illustrated in one or more other figures, for example, to generate an example embodiment not explicitly illustrated or described. All of the features illustrated in any one of the figures are not necessarily essential for describing the example embodiments, and some features may be omitted.

Some or all of the above-described example embodiments may be described as the following supplementary notes, but are not limited thereto.

### (Supplementary Note 1)

An optical module including:
a substrate;
an integrated circuit configured to have a first surface and a second surface in an opposite side to the first surface, and be attached to the substrate in such a way that the first surface faces the substrate;
an optical component configured to be attached to the substrate;
an optical fiber configured to be connected to the optical component; and
a base material portion configured to be attached to the integrated circuit, and hold at least a part of the optical fiber, wherein
the optical fiber includes
a first portion configured to pass through the second surface, and
a second portion configured to pass through the second surface, and
the optical component includes
an optical transmitter configured to output an optical signal,
an optical receiver configured to receive the optical signal, and
an optical fiber type amplifier configured to amplify the optical signal,
the optical module further including:
a first optical fiber accommodating portion configured to accommodate a part of the optical fiber not being held by the base material portion; and
a second optical fiber accommodating portion configured to accommodate the optical fiber type amplifier, wherein
the first optical fiber accommodating portion is provided on the second optical fiber accommodating portion in a laminated manner, and
one end of the second portion is connected to the optical fiber being connected to the optical receiver.

### (Supplementary Note 2)

A communication apparatus including the optical module according to supplementary note 1.

According to the present disclosure, it is possible to provide an optical module and a communication apparatus that can be mounted at high density.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. An optical module comprising:
a substrate;
an integrated circuit configured to have a first surface and a second surface in an opposite side to the first surface, and be attached to the substrate in such a way that the first surface faces the substrate;
an optical component configured to be attached to the substrate;
an optical fiber configured to be connected to the optical component; and
a base material portion configured to be attached to the integrated circuit, and hold at least a part of the optical fiber, wherein
the optical fiber includes
a first portion configured to pass through the second surface, and
a second portion configured to pass through the second surface.

2. The optical module according to claim 1, wherein at least any of the first portion and the second portion intersects one side of the second surface and the other side opposed to the one side.

3. The optical module according to claim 1, wherein the base material portion includes
a first base material portion holding the first portion, and
a second base material portion holding the second portion.

4. The optical module according to claim 3, wherein the second surface is exposed between the first base material portion and the second base material portion.

5. The optical module according to claim 1, wherein the base material portion includes a cutout portion penetrating to the second surface in at least a part of a surface holding the optical fiber other than an area where a path of the optical fiber is located.

6. The optical module according to claim 1, wherein the optical component includes
an optical transmitter configured to output an optical signal, and
an optical fiber type amplifier configured to amplify the optical signal,
the optical module further comprising:
a first optical fiber accommodating portion configured to accommodate a part of the optical fiber not being held by the base material portion; and
a second optical fiber accommodating portion configured to accommodate the optical fiber type amplifier,
wherein the first optical fiber accommodating portion is provided on the second optical fiber accommodating portion in a laminated manner.

7. The optical module according to claim 6, further comprising a heat sink configured to have a cooling function,
wherein the integrated circuit, the optical transmitter, and the heat sink are arranged in such a way as to align in a plane parallel to one surface of the substrate.

8. The optical module according to claim 7, further comprising a housing configured to accommodate the substrate, the integrated circuit, the optical component, the optical fiber, the base material portion, the first optical fiber accommodating portion, the second optical fiber accommodating portion, and the heat sink, wherein
a thickness of the heat sink from the one surface is greater than the thickness of the integrated circuit from the one surface, and
a space is formed on a second surface side of the integrated circuit.

9. The optical module according to claim 6, wherein
the optical component further includes a light source for generating light used for the optical signal, and
one end of the first portion is connected to the optical fiber being connected to the light source.

10. A communication apparatus comprising an optical module, wherein
the optical module includes
a substrate;
an integrated circuit configured to have a first surface and a second surface in an opposite side to the first surface, and be attached to the substrate in such a way that the first surface faces the substrate;
an optical component configured to be attached to the substrate;
an optical fiber configured to be connected to the optical component; and
a base material portion configured to be attached to the integrated circuit, and hold at least a part of the optical fiber, wherein
the optical fiber includes
a first portion configured to pass through the second surface, and
a second portion configured to pass through the second surface.

11. The communication apparatus according to claim 10, wherein at least any of the first portion and the second portion intersects one side of the second surface and the other side opposed to the one side.

12. The communication apparatus according to claim 10, wherein the base material portion includes
a first base material portion holding the first portion, and
a second base material portion holding the second portion.

13. The communication apparatus according to claim 12, wherein the second surface is exposed between the first base material portion and the second base material portion.

14. The communication apparatus according to claim 10, wherein the base material portion includes a cutout portion penetrating to the second surface in at least a part of a surface holding the optical fiber other than an area where a path of the optical fiber is located.

15. The communication apparatus according to claim 10, wherein the optical component includes
an optical transmitter configured to output an optical signal, and
an optical fiber type amplifier configured to amplify the optical signal,
the optical module further comprising:
a first optical fiber accommodating portion configured to accommodate a part of the optical fiber not being held by the base material portion; and
a second optical fiber accommodating portion configured to accommodate the optical fiber type amplifier,
wherein the first optical fiber accommodating portion is provided on the second optical fiber accommodating portion in a laminated manner.

16. The communication apparatus according to claim 15, further comprising a heat sink configured to have a cooling function,
wherein the integrated circuit, the optical transmitter, and the heat sink are arranged in such a way as to align in a plane parallel to one surface of the substrate.

17. The communication apparatus according to claim 16, further comprising a housing configured to accommodate the substrate, the integrated circuit, the optical component, the optical fiber, the base material portion, the first optical fiber accommodating portion, the second optical fiber accommodating portion, and the heat sink, wherein
a thickness of the heat sink from the one surface is greater than the thickness of the integrated circuit from the one surface, and
a space is formed on a second surface side of the integrated circuit.

18. The communication apparatus according to claim 17, wherein
the optical component further includes a light source for generating light used for the optical signal, and
one end of the first portion is connected to the optical fiber being connected to the light source.

19. An optical module comprising:
a substrate;
an integrated circuit configured to have a first surface and a second surface in an opposite side to the first surface, and be attached to the substrate in such a way that the first surface faces the substrate;
an optical component configured to be attached to the substrate;
an optical fiber configured to be connected to the optical component; and
a base material portion configured to be attached to the integrated circuit, and hold at least a part of the optical fiber, wherein
the optical fiber includes
a first portion configured to pass through the second surface, and
a second portion configured to pass through the second surface, and
the optical component includes
an optical transmitter configured to output an optical signal,
an optical receiver configured to receive the optical signal, and
an optical fiber type amplifier configured to amplify the optical signal,
the optical module further including:
a first optical fiber accommodating portion configured to accommodate a part of the optical fiber not being held by the base material portion; and
a second optical fiber accommodating portion configured to accommodate the optical fiber type amplifier, wherein
the first optical fiber accommodating portion is provided on the second optical fiber accommodating portion in a laminated manner, and
one end of the second portion is connected to the optical fiber being connected to the optical receiver.

20. A communication apparatus comprising the optical module according to claim 19.
